(19) United States
(12) Patent Application Publication
(10) Pub. No.: US 2022/0083030 A1
(43) Pub. Date: Mar. 17, 2022

(54) COOPERATIVE WORK CONTROL SYSTEM, COOPERATIVE WORK CONTROL DEVICE, AND COOPERATIVE WORK CONTROL METHOD

(71) Applicant: HITACHI, LTD., Tokyo (JP)

(72) Inventors: Takumi OISHI, Tokyo (JP); Nobuyuki MURANAKA, Tokyo (JP)

(73) Assignee: HITACHI, LTD., Tokyo (JP)

(21) Appl. No.: 17/395,663

(22) Filed: Aug. 6, 2021

(30) Foreign Application Priority Data
Sep. 15, 2020 (JP) 2020-154447

(51) Int. Cl. G05B 19/418

(52) U.S. Cl. CPC G05B 19/41815; G05B 19/4185; G05B 19/4183; G05B 19/41895

(57) ABSTRACT

An object of the present invention is to improve the work efficiency of a moving cooperative work of a first device and a second device. When controlling a cooperative work in a first device and a second device that perform the cooperative work in cooperation with each other, the working status of a first work of the first device is collected, and a second work of the second device is controlled on the basis of the working status.

### BACKGROUND

The present invention relates to a cooperative work control system, a cooperative work control device, and a cooperative work control method.

In recent years, in operations in a distribution warehouse, the work efficiency of the operations in the distribution warehouse has been deteriorated due to labor shortages and the like. Therefore, a technique for improving the work efficiency of the operations in the distribution warehouse has been required.

The related technique thereof is described in, for example, Japanese Unexamined Patent Application Publication No. 2019-150911. Japanese Unexamined Patent Application Publication No. 2019-150911 discloses a technique for improving the work efficiency of a cooperative work to move products that is repeatedly performed by an automated guided vehicle that carries the products and a robotics arm that takes out the products.

### SUMMARY

In Japanese Unexamined Patent Application Publication No. 2019-150911, however, the working state of the automated guided vehicle is considered, but the working status of the robotics arm is not considered. For this reason, in Japanese Unexamined Patent Application Publication No. 2019-150911, it is difficult to improve the work efficiency of the cooperative work to move products between the robotics arm (first device) and the automated guided vehicle (second device).

An object of the present invention is to improve the work efficiency of a moving cooperative work of a first device and a second device.

A moving speed control system of moving bodies according to an aspect of the present invention is a cooperative work control system that includes: a first device for performing a first work; a second device for performing a second work in cooperation with the first work of the first device; and a cooperative work control device for controlling the first work of the first device and the second work of the second device. In the moving speed control system, the cooperative work control device collects the working status of the first work of the first device and controls the second work of the second device on the basis of the working status.

According to an aspect of the present invention, it is possible to improve the work efficiency of a moving cooperative work of a first device and a second device.

### BRIEF DESCRIPTION OF THE DRAWINGS

FIG. 1 is a configuration diagram of a moving body control system of a first embodiment;

FIG. 2 is a functional configuration diagram of a robotics arm;

FIG. 3 is a functional configuration diagram of an automated guided vehicle;

FIG. 4 is a functional configuration diagram of a moving body control device;

FIG. 5 is a work sequence diagram of the first embodiment;

FIG. 6 is a diagram for showing an information management table of moving bodies of the first embodiment;

FIG. 7 is a work flow diagram of the robotics arm;

FIG. 8 is a work flow diagram of the automated guided vehicle;

FIG. 9 is a work flow diagram of the moving body control device;

FIG. 10 is a diagram for showing a setting value input screen;

FIG. 11 is a diagram for showing a status display screen;

FIG. 12 is a functional configuration diagram of a base station;

FIG. 13 is a work sequence diagram of a second embodiment;

FIG. 14 is a diagram for showing an information management table of moving bodies of the second embodiment;

FIG. 15 is a diagram for showing a control table of assigning order of transmission slot;

FIG. 16 is a work flow diagram of a base station;

FIG. 17 is a work flow diagram of a moving body control device of the second embodiment;

FIG. 18 is a work sequence diagram of a third embodiment;

FIG. 19 is an explanatory diagram of an area of cooperative work; and

FIG. 20 is a diagram for showing a configuration of a cooperative work control device.

### DETAILED DESCRIPTION

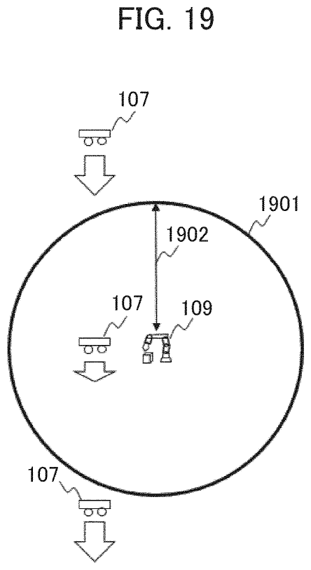

First, embodiments of the present invention will be described with reference to FIG. 19.

Hereinafter, a case in which a robotics arm 109 is exemplified as a first device, automated guided vehicles 107 (hereinafter, referred to as AGVs) are exemplified as second devices, and products carried by the AGVs 107 are taken out by the robotics arm 109 as a cooperative work will be described.

The cooperative work of the robotics arm 109 and the AGVs 107 is repeated every time the AGVs 107 arrive one after another. Details of the repetitive operation are as follows.

As shown in FIG. 19, an area where products carried by the AGVs 107 can be taken out is defined on the basis of the performance of the robotics arm 109. Hereinafter, this area will be referred to as an area of cooperative work 1901, and the radius thereof will be referred to as the length 1902 of the area of cooperative work. When the AGV 107 traveling at a constant speed in a warehouse approaches the robotics arm 109 as the destination, the AGV 107 decelerates before reaching the area of cooperative work 1901, and moves at a slow cooperative work speed at which the robotics arm 109 can take out the products in the area of cooperative work 1901.

During this time, the robotics arm 109 takes out the products from the AGV 107. After the AGV 107 exits the area of cooperative work 1901, the AGV 107 accelerates and travels at the original speed in the warehouse. Here, a period during which the AGV 107 moves at the cooperative work speed in the area of cooperative work 1901 is defined as a work time per cooperative work (work time per cycle).

The work efficiency of the cooperative work can be expressed by the work time per cycle. When only one AGV 107 can exist in the area of cooperative work 1901, the work efficiency of the cooperative work is improved by making the cooperative work speed of the AGV 107 faster and shortening the work time per cycle.

Plural AGVs 107 can exist in the area of cooperative work 1901, and the robotics arm 109 can have plural arms and take out the products from the AGVs 107 that are different from each other. The relation that the work efficiency of the cooperative work is improved by shortening the work time per cycle is similar.

However, the cooperative work speed of the AGV 107 cannot be infinitely made faster, and needs to be the speed at which the robotics arm 109 can take out the products. That is, it is necessary to adjust the cooperative work speed of the AGV 107 to the work speed of picking and placing products by the robotics arm 109. In the embodiment, in the cooperative work to move products of the robotics arm 109 and the AGV 107, in consideration of the working state of the robotics arm 109, the work efficiency of the cooperative work is improved by shortening the work time (hereinafter, referred to as work time per cycle) per cooperative work that is repeatedly performed.

It should be noted that the first device includes an assembly robot for assembling components, a machining robot for punching holes, a bar code reader for reading two-dimensional or three-dimensional bar codes, or the like, and can be implemented in the same manner as in the embodiment.

In addition, the second device includes a belt conveyor, a hoist, or the like, and can be implemented in the same manner as in the embodiment. In one cooperative work of moving the products, assembling, machining, reading the bar codes, and the like, the first device performs operations corresponding to the number of products to be moved, the number of components to be assembled, the number of products to be machined, and the number of bar codes to be read. This number is referred to as the number of works per cycle. In addition, in the embodiment, the number of works per unit time, for example, per second is defined as work throughput.

Hereinafter, embodiments will be described in detail using the drawings.

### First Embodiment

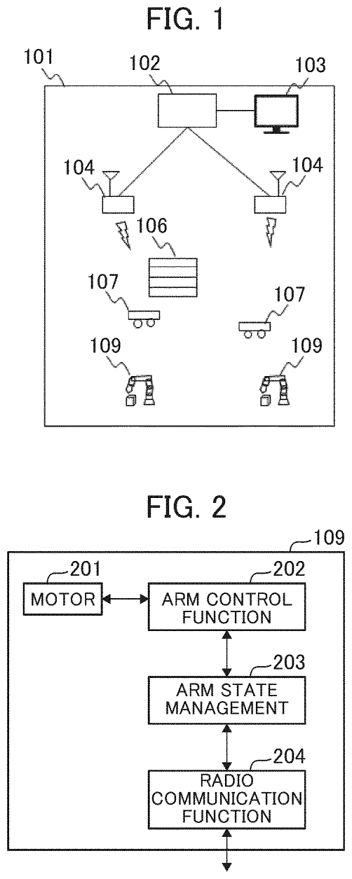

With reference to FIG. 1, a configuration of a cooperative work control system 101 of a first embodiment will be described.

The cooperative work control system 101 has a cooperative work control device 102, an input display device (for example, a display) 103, a base station 104, a storage shelf 106 for products, an AGV 107, and a robotics arm 109.

The AGV 107 and the robotics arm 109 transmit and receive information to/from the cooperative work control device 102 by radio communication via the base station 104. The AGV 107 repeatedly loads products at the storage shelf 106 and carries the same to the robotics arm 109. The robotics arm 109 repeats taking out the products from the AGV 107 that has arrived.

In the first embodiment, the time required for the AGV 107 to stay in the area of cooperative work 1901 (see FIG. 19) of the robotics arm 109 is shortened, and the work time per cooperative work is shortened. That is, when the AGV 107 moves in the area of cooperative work 1901 of the robotics arm 109, the cooperative work speed of the AGV 107 is controlled so as not to decrease the work throughput of the robotics arm 109.

With reference to FIG. 2, a configuration of the robotics arm 109 will be described.

The robotics arm 109 has a motor 201 for moving an arm, an arm control function 202 for controlling a motor, an arm state management function 203 for managing the working state of the arm to calculate the work throughput, and a radio communication function 204 for communicating with the cooperative work control device 102.

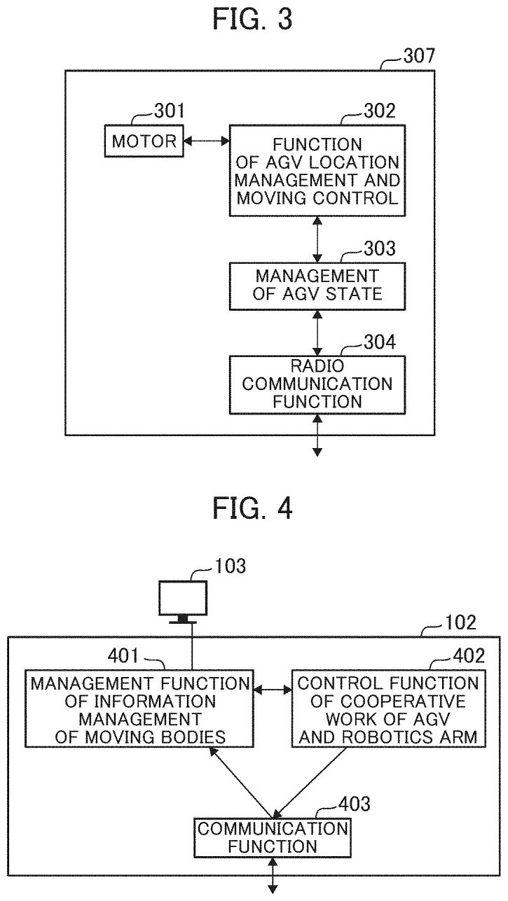

With reference to FIG. 3, a configuration of the AGV 107 will be described.

The AGV 107 has a motor 301 for moving the AGV 107, a function of AGV location management and moving control 302 for managing the current location of the AGV 107 to control the moving speed, a management function of AGV state for managing the working state of the AGV, and a radio communication function 304 for communicating with the cooperative work control device 102.

With reference to FIG. 4, a configuration of the cooperative work control device 102 will be described.

The cooperative work control device 102 has a management function of information management of moving bodies 401 for managing information related to the AGV 107, a control function of cooperative work of AGV and robotics arm 402 for controlling the movement of the AGV, and a communication function 403 for communicating with the AGV 107 and the robotics arm 109.

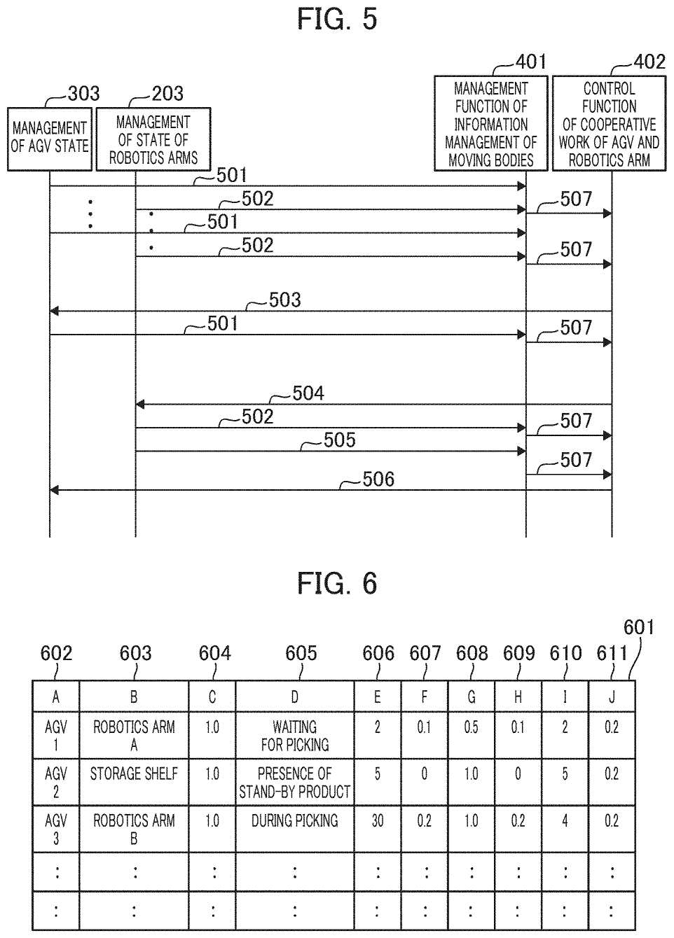

With reference to FIG. 5, a work sequence in which the AGV 107 arrives at the robotics arm 109 and executes one cycle of the cooperative work will be described.

The management function of AGV state 303 of the AGV 107 traveling in the warehouse periodically reports the current location and speed thereof to the management function of information management of moving bodies 401 through a report of location and speed 501. As similar to the above, the management function of state of robotics arms 203 periodically reports the working state of the arm to the management function of information management of moving bodies 401 through a report of working state 502.

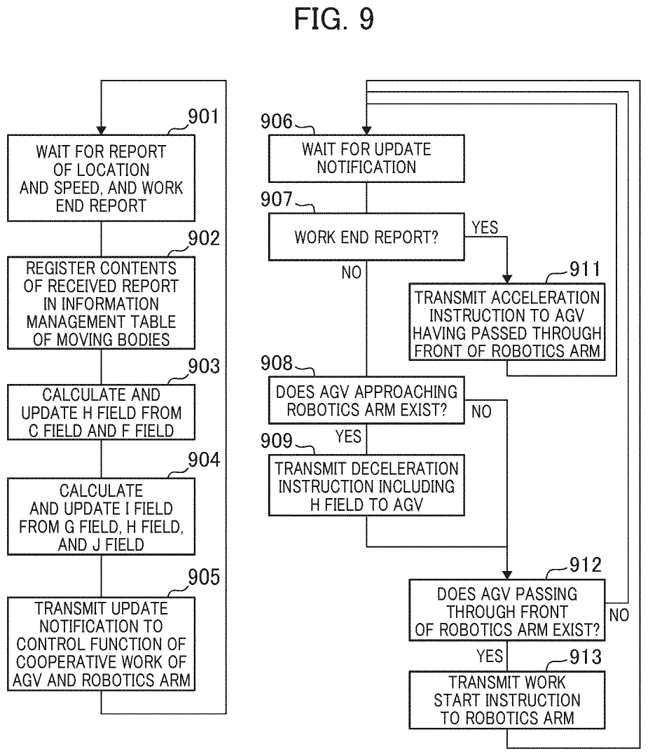

When receiving the report of location and speed 501 or the report of working state 502, the management function of information management of moving bodies 401 transmits an update notification 507 to the control function of cooperative work of AGV and robotics arm 402. Every time the control function of cooperative work of AGV and robotics arm 402 receives the update notification 507, the control function of cooperative work of AGV and robotics arm 402 monitors a distance between each AGV 107 and the robotics arm 109. Then, when the distance is smaller than a value calculated in advance, a deceleration instruction 503 is transmitted to the AGV 107, and when the distance is smaller than a preset value, a work start instruction 504 is transmitted to the robotics arm 109. The above detailed work will be described with reference to FIG. 9.

The AGV having received the deceleration instruction 503 decelerates up to a designated speed and continues to move at the designated speed. The robotics arm 109 having received the work start instruction 504 starts picking and placing products, and transmits a work end report 505 to the management function of information management of moving bodies 401 when finishing the work. The management function of information management of moving bodies 401 having received the report transmits the update notification 507 to the control function of cooperative work of AGV and robotics arm 402. The control function of cooperative work of AGV and robotics arm 402 having received the update notification 507 transmits an acceleration instruction 506 to the AGV 107. The AGV 107 having received the acceleration instruction 506 accelerates up to a designated speed and continues to move at the designated speed. Each AGV 107 and the robotics arm 109 repeat the above sequence work.

With reference to FIG. 6, an example of an information management table of moving bodies 601 managed by the management function of information management of moving bodies 401 will be described.

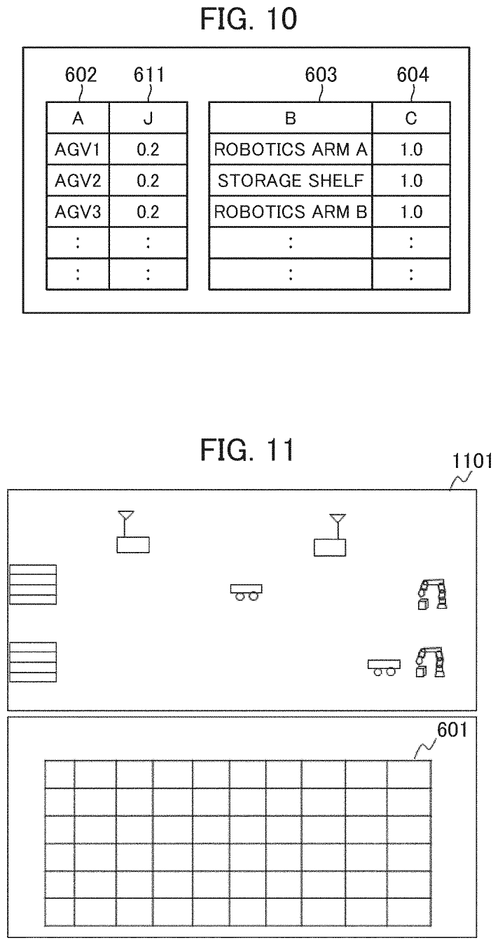

A moving body ID field 602 is a field for registering an ID uniquely assigned to each AGV, and is used to identify the AGV in all the communications between the AGV 107 and the management function of information management of moving bodies 401. This value can be input on a setting screen to be described with reference to FIG. 10. A destination field 603 is a field for registering the next destination of the AGV 107, and is given to each AGV 107 from a work planning system existing separately from the system according to the first embodiment.

A length-of-area-of-cooperative-work field 604 registers the length of the area within the range where the cooperative work with the AGV 107 can be performed, and is determined by the performance of each of the robotics arm 109 and the storage shelf 106. This value can be input from the setting screen to be described with reference to FIG. 10. A state field of destination 605 registers the working state of the robotics arm 109.

The contents reported through the report of working state 502 of FIG. 5 are registered in the field. A distance-from-destination field 606 is a field for registering a distance between the AGV 107 and the robotics arm 109, and registers the contents reported through the report of location and speed 501 of FIG. 5. A work throughput field 607 is a field for registering the work throughput of the robotics arm 109, and registers the contents reported through the report of working state 502 of FIG. 5. A current moving speed field 608 is a field for registering the moving speed of the AGV 107, and registers the contents reported through the report of location and speed 501.

A cooperative work speed field 609 is a field for registering a moving speed at which the AGV 107 moves in the area of cooperative work 1901 (see FIG. 19) of the robotics arm 109, and registers a value calculated on the basis of the length-of-area-of-cooperative-work field 604 and the work throughput field 607. A distance-to-deceleration-point field 610 is a field for registering a value calculated on the basis of the current moving speed 608, the cooperative work speed 609, and deceleration performance 611. A deceleration performance field 611 is a field for registering the deceleration performance of the AGV 107, and can be input from the setting screen to be described with reference to FIG. 10.

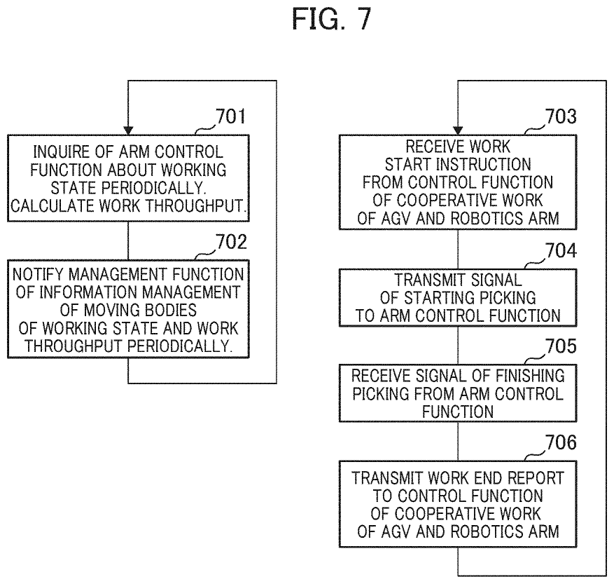

With reference to FIG. 7, a work flow of the robotics arm state management unit 203 of the robotics arm 109 will be described.

In Step 701, the arm control function 202 is periodically inquired about the current arm operation state. The arm operation state includes, for example, idle, moving arm, picking, moving arm, placing, returning arm, abnormal stopping, repicking (dropped although grasped once), or the like. For example, there are cases in which an abnormal operation is required, such as an emergency stop of the arm due to contact with the AGV 107 or grasping again due to dropping of the product. In order to calculate the work throughput value including these abnormal operations in addition to the normal operation, the time elapsed from the idle state to the next idle state is measured to obtain the reciprocal.

In Step 702, the obtained operation state and work throughput value are reported to the management function of information management of moving bodies 401 through the report of working state 502. In addition, when the work start instruction 504 is received in Step 703, a signal of starting picking is transmitted to the arm control function 202 in Step 704. When a signal of finishing picking is received in Step 705, the work end report 505 is transmitted in Step 706.

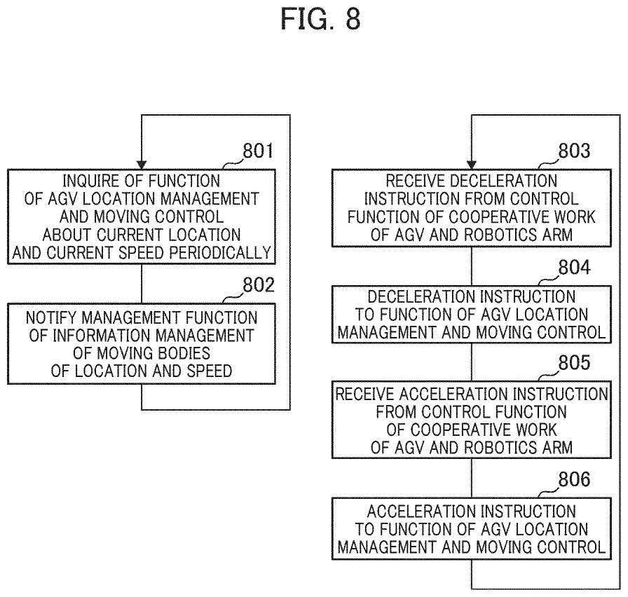

With reference to FIG. 8, a work flow of the management function of AGV state 303 of the AGV 107 will be described.

In Step 801, the function of AGV location management and moving control 302 is periodically inquired about the current moving location and speed, and the obtained moving speed and location are reported to the management function of information management of moving bodies 401 through the report of location and speed 501 in Step 802. In addition, when receiving the deceleration instruction 503 in Step 803, a deceleration instruction to the designated speed is transmitted to the function of AGV location management and moving control 302 in Step 804.

When receiving the acceleration instruction 506 in Step 805, an acceleration instruction is transmitted to the function of AGV location management and moving control 302 in Step 806.

With reference to FIG. 9, a work flow of the cooperative work control device 102 will be described.

When the management function of information management of moving bodies 401 receives the report of location and speed 501 and the report of working state 502 in Step 901, the received contents are registered in the information management table of moving bodies 601 (see FIG. 6) in Step 902. In Step 903, a value to be registered in the cooperative work speed field 609 is calculated on the basis of the values of the length-of-area-of-cooperative-work field 604 and the work throughput field 606. For example, the length 1902 of the area of cooperative work (see FIG. 19) can be calculated by being divided by the work throughput.

It should be noted that when comparing a case in which the number of works per cycle of the robotics arm 109 is 1 with a case in which the number of works per cycle of the robotics arm 109 is N, the work time per cycle is N times when the work throughput is the same. That is, the value of the cooperative work speed is 1/N. In Step 904, the distance 610 to the deceleration point is calculated on the basis of the values of the current moving speed field 608, the cooperative work speed field 609, and the deceleration performance field 611. For example, the distance 610 is calculated in such a manner that the moving speed during the cooperative work is subtracted from the current moving speed and the value is divided by the deceleration performance. In Step 905, the update notification 507 is transmitted to the control function of cooperative work of AGV and robotics arm 402.

When the control function of cooperative work of AGV and robotics arm 402 receives the update notification 507 in Step 906, it is confirmed in Step 907 whether or not the notification is the work end report. In the case of YES, the acceleration instruction 506 is transmitted to the AGV 107 moving in the area of cooperative work 1901 (see FIG. 19) of the robotics arm in Step 911. In the case of NO, it is confirmed whether or not an AGV 107 approaching the robotics arm 109 exists by using the information management table of moving bodies 601 (see FIG. 6) in Step 908. For example, it is confirmed that the value of the distance-from-destination field 606 is smaller than the sum of the value of the length-of-area-of-cooperative-work field 604 and the value of the distance-to-deceleration-point field 610. In the case of NO, the flow proceeds to Step 912, and in the case of YES, the deceleration instruction 503 is transmitted to the AGV in Step 909.

Then, it is confirmed in Step 912 whether or not the AGV 107 exists in the area of cooperative work 1901 of the robotics arm 109 by using the information management table of moving bodies 601. For example, it is confirmed that the value of the distance-from-destination field 606 is smaller than the length-of-area-of-cooperative-work field 604. In the case of NO, the flow returns to Step 906. In the case of YES, the work start instruction 504 is transmitted to the robotics arm.

With reference to FIG. 10, an example of a setting value input screen displayed on the input display device (display 103) will be described.

The respective fields of the drawing are the same as those of the information management table of moving bodies 601 in FIG. 6, and the values input here are registered in the information management table of moving bodies 601.

With reference to FIG. 11, an example of a cooperative work status display screen displayed on the input display device (display) 103 will be described.

The upper part represents a map in the warehouse to which the system according to the first embodiment is applied. The current position, moving direction, and destination of each AGV 107 can be displayed on the map, and the working status of the cooperative work can be displayed so that the user can understand at a glance. The lower part displays the contents of the information management table of moving bodies 601 of FIG. 6 and provides the user with the current status of each AGV 107.

If the AGV 107 cannot move due to the occurrence of troubles such as failures or battery exhaustion, the troubles can be detected by monitoring the current moving speed field 608 of FIG. 6. For example, if the value is 0 for three consecutive cycles as a result of periodically monitoring the field, it can be considered that some kind of trouble has occurred. Even in the case where a trouble occurs in an AGV 107, if the other AGVs 107 continue to operate, the above-described first embodiment can be executed. In the case where the occurrence of troubles is detected, the occurrence can be notified to the user by, for example, changing the color of the AGV 107 to red on the map 1101 of FIG. 11, and the user can start the trouble recovery work.

As described above, the cooperative work control system 101 of the first embodiment has the first device for performing a first work, the second device for performing a second work in cooperation with the first work of the first device, and the cooperative work control device 102 for controlling the first work of the first device and the second work of the second device. The cooperative work control device 102 collects the working status of the first work of the first device and controls the second work of the second device on the basis of the working status.

In addition, the cooperative work control device 102 controls the second work of the second device using a throughput value that is the number of works of the first work that can be executed per unit time by the first device as the working status.

In addition, when the cooperative work control device 102 detects that the second device is moving inside the area of cooperative work where the second device can work in cooperation with the first work of the first device, the moving speed of the second device is controlled as the control of the second work of the second device on the basis of the throughput value.

Here, for example, the second device is configured using the AGV 107 for carrying products, and the first device is configured using the robotics arm 109 for taking out the products carried by the AGV 107.

The area of cooperative work is, for example, an area shown by 1901 of FIG. 19, and is determined in advance on the basis of a range where the robotics arm 109 can take out the products carried by the AGV 107 in accordance with the performance of the robotics arm 109. As the second work, the AGV 107 repeats carrying the products to the robotics arm 109. As the first work, the robotics arm 109 repeats taking out the products from the AGV 107.

According to the first embodiment, the work efficiency of the cooperative work can be improved by shortening the work time of one cycle of the cooperative work when the first device and the second device repeat the cooperative work.

### Second Embodiment

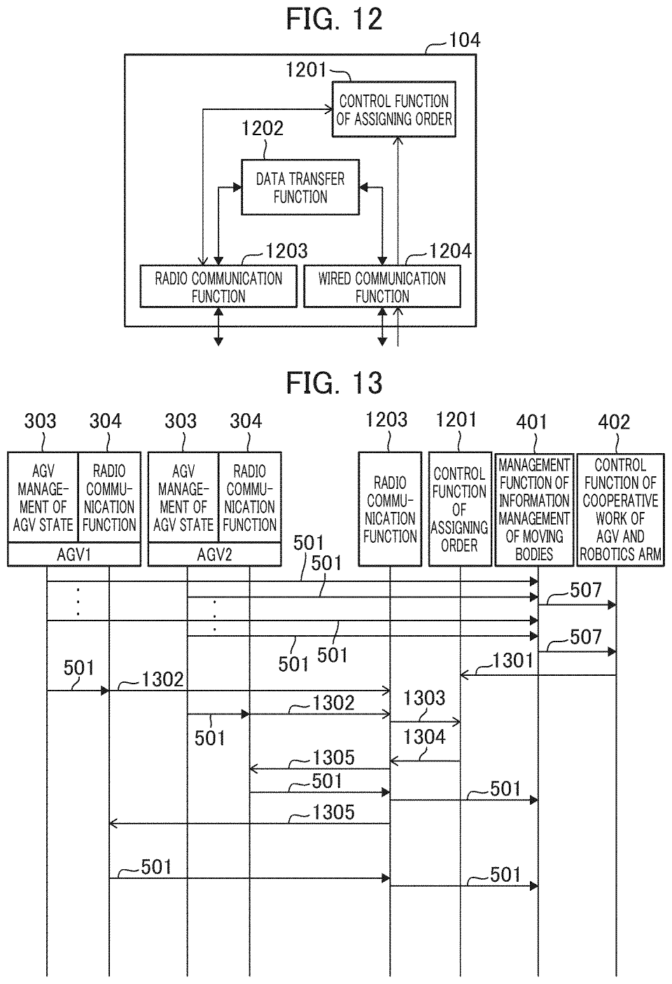

With reference to FIG. 12, a configuration of a cooperative work control system 101 of a second embodiment will be described.

The system configuration is the same as that of the cooperative work control system 101 of the first embodiment shown in FIG. 1, and the description thereof will be omitted.

In the first embodiment, the AGV 107, the robotics arm 109, and the cooperative work control device 102 perform radio communications via the base station 104. Since the radio communication status such as the received radio wave intensity of the radio changes with time, there is a possibility that a delay time occurs in the report of location and speed 501 and the report of working state 502 and a delay occurs in information transmission from the AGV 107 and the robotics arm 109 to the cooperative work control device 102. When the delay time actually occurs, the entire sequence after the deceleration instruction 503 to the AGV 107 from the cooperative work control device 102 in FIG. 5 is delayed.

Although the work can be started from the viewpoint of the robotics arm 109, the start of the cooperative work is delayed because the reception of the work start instruction 504 is delayed. The work time per cycle is increased by the delay time. Further, since the delay time is accumulated and increased every time a delay time occurs in radio communications in one cycle of the cooperative work, it is required to prevent the occurrence of the delay time. Although a large number of AGVs 107 and robotics arms 109 exist in the warehouse and perform radio communications with the cooperative work control device 102, it is not necessary to prevent the occurrence of the delay time in all the radio communications.

Therefore, it is possible to realize the prevention of the delay time by preferentially communicating only the radio communications directly related to the cooperative work and postponing the other radio communications. In the second embodiment, a method of giving priority to radio communications directly related to the cooperative work is described.

With reference to FIG. 12, a configuration of the base station 104 will be described.

The base station 104 has a control function of assigning order 1201, a radio communication function 1203, a wired communication function 1204, and a data communication function 1202 for transferring information between the radio communication function 1203 and the wired communication function 1204.

With reference to FIG. 13, a sequence in which two AGVs 107 transmit the report of location and speed 501 to the cooperative work control device 102 by radio communications will be described. This work sequence is the same in other radio communications such as the report of working state 502.

As similar to the first embodiment, AGV state management units 303 of an AGV1 and an AGV2 traveling in the warehouse periodically transmit the report of location and speed 501 to the management function of information management of moving bodies 401 of the cooperative work control device 102.

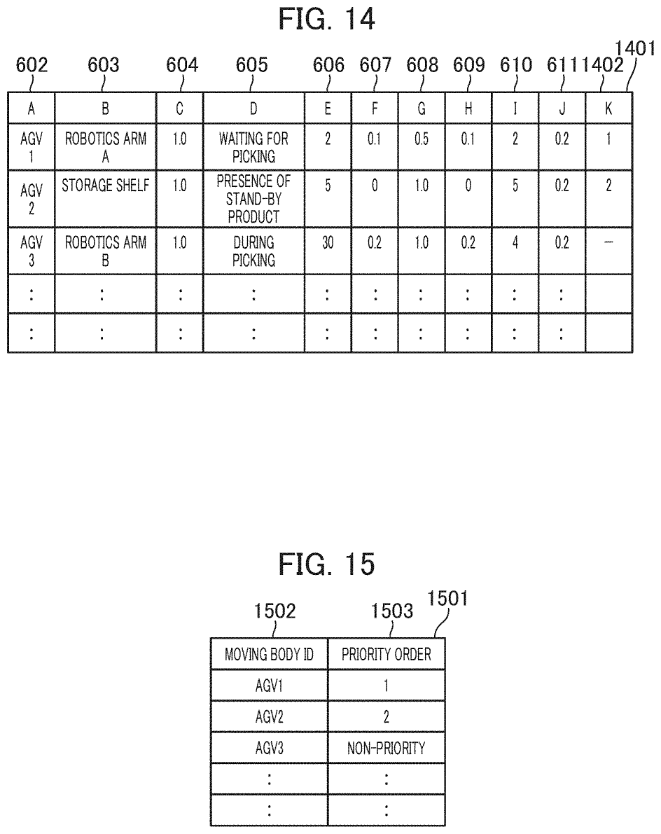

The management function of information management of moving bodies 401 having received the report of location and speed 501 transmits the update notification 507 to the control function of cooperative work of AGV and robotics arm 402. The control function of cooperative work of AGV and robotics arm 402 having received the update notification 507 refers to a priority order field 1402 of the information management table of moving bodies 1401 (see FIG. 14) and transmits a priority order notification 1301 to an assigning order control unit 1201. Here, it is assumed that the AGV2 approaches the robotics arm 109 as the destination. The AGV state management units 303 of the AGV1 and the AGV2 periodically transmit the report of location and speed 501.

The radio communication function 1203 of each of the AGV1 and the AGV2 receives the report of location and speed 501 and transmits a request of transmission slot assignment 1302 to the base station 104. When receiving the request of transmission slot assignment 1302 from each of the AGV1 and the AGV2, the radio communication function 1203 of the base station 104 transmits a request of assigning order 1303 to the control function of assigning order 1201. The control function of assigning order 1201 having received the request of assigning order 1303 determines the transmission order of the AGV1 and the AGV2 by referring to a control table of assigning order of transmission slot 1501 (see FIG. 15).

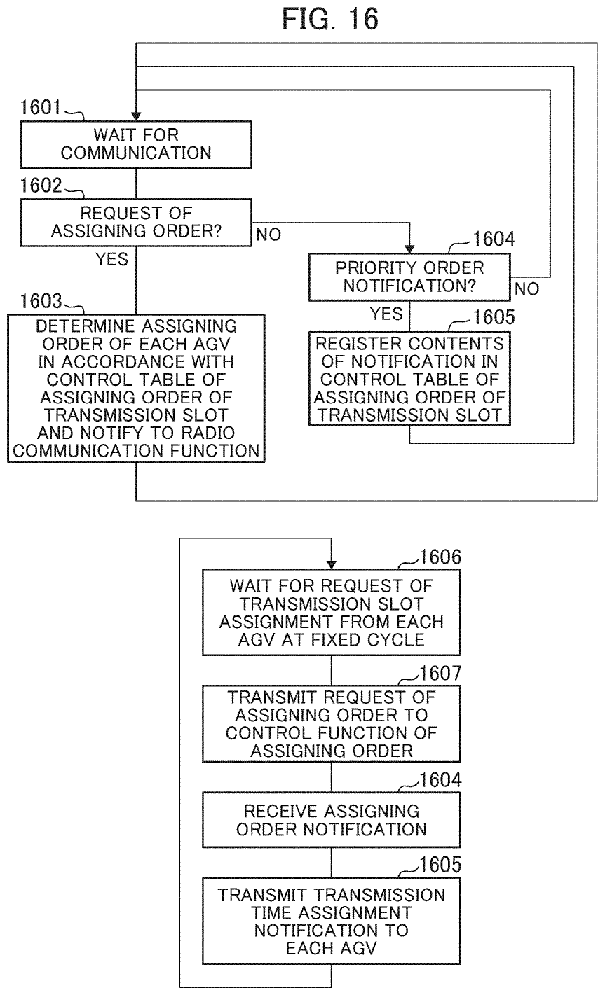

Next, an assigning order notification 1304 including the transmission order is transmitted to the radio communication function 1203. The radio communication function 1203 determines the transmission start time and the length of the transmission time of each of the AGV1 and the AGV2 on the basis of the transmission order of the AGV1 and the AGV2 included in the received assigning order notification 1304, and transmits the same included in a transmission time assignment notification 1305 to the AGV1 and the AGV2. A method of calculating the transmission start time and the length of the transmission time will be described with reference to FIG. 16.

The radio communication function 304 of each of the AGV1 and the AGV2 transmits the report of location and speed 501 to the base station 104 when the transmission start time included in the received transmission time assignment notification 1305 comes. In the base station 104, the data transfer function 1202 transfers the report of location and speed 501 received by the radio communication function 1203 to the wired communication function 1204, and the wired communication function 1204 transmits the same to the management function of information management of moving bodies 401.

FIG. 14 shows an example of the information management table of moving bodies 1401 managed by the management function of information management of moving bodies 401. This table is obtained by adding the priority order field 1402 to the information management table of moving bodies 601 in the first embodiment.

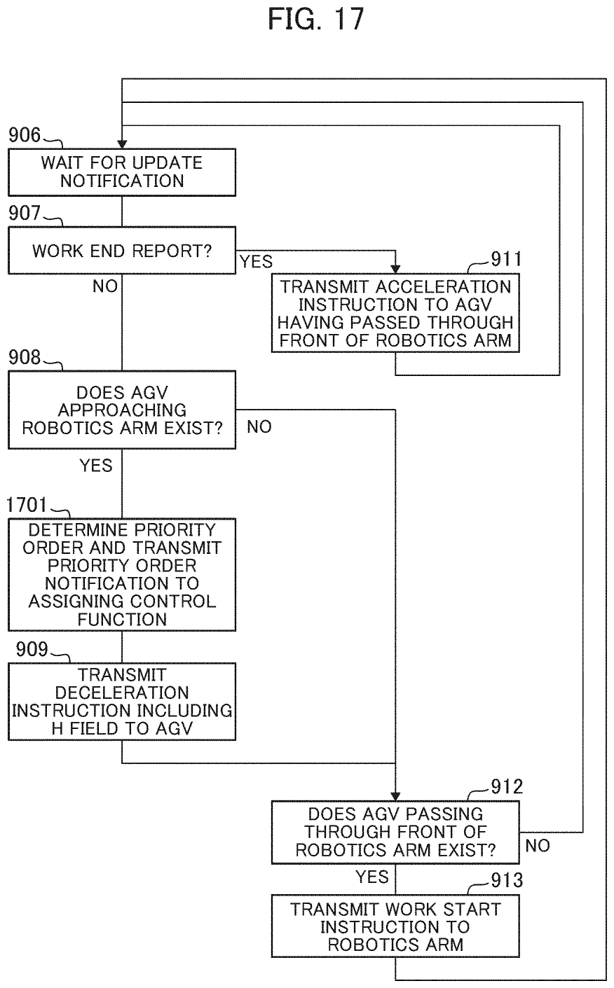

The management function of information management of moving bodies 401 calculates and registers the value of the priority order field 1402 every time the update notification 507 is received. The calculation method thereof will be described with reference to FIG. 17.

FIG. 15 shows an example of the control table of assigning order of transmission slot 1501 held by the base station 104. The table is configured using a moving body ID field 1502 and a priority order field 1503. The moving body ID registered in the moving body ID field 1502 is the same as that registered in the moving body ID field 602 of FIG. 14. The priority registered in the priority field 1503 is the same as that registered in the priority order field 1402 of FIG. 14.

With reference to FIG. 16, a work flow of the base station 104 will be described.

The control function of assigning order 1201 waits for communications from the AGV 107 and the cooperative work control device 102 in Step 1601. It is checked in Step 1602 whether or not the received communication content is the request of assigning order 1303. If YES, the flow proceeds to Step 1603, and if NO, the flow proceeds to Step 1604. In Step 1603, the transmission time assigning order of each AGV 107 is determined in accordance with the contents of the control table of assigning order of transmission slot 1501, and the assigning order notification 1304 including the contents thereof is transmitted to the radio communication function 1203.

It is checked in Step 1604 whether or not the received communication content is the priority order notification 1301. If YES, the flow proceeds to Step 1605, and if NO, the flow returns to Step 1601. In Step 1605, the contents of the priority order notification 1301 are registered in the control table of assigning order of transmission slot 1501.

The radio communication function 1202 waits for the request of transmission slot assignment from each AGV at a fixed cycle in Step 1606. This cycle is set in advance in each base station 104. In Step 1607, the request of assigning order 1303 is transmitted to the control function of assigning order 1201. In Step 1608, the assigning order notification 1304 is received from the control function of assigning order 1201, and the contents thereof are registered in the control table of assigning order of transmission slot 1501.

In Step 1605, the transmission start time and the length of the transmission time are assigned to each AGV in accordance with the contents of the control table of assigning order of transmission slot 1501, and the transmission time assignment notification 1305 including the contents thereof is transmitted. For example, the transmission start time is determined as follows. In general, the base station 104 periodically secures time required to perform transmission to the AGV 107 and the robotics arm 109 in the warehouse. This periodically-secured time is called a slot. Each AGV 107 performs transmission in order in a slot to the AGV 107. Usually, first come, first served. However, in the second embodiment, the transmission start time is determined so that the communications of the AGVs 107 are not overlapped from the top of the slots in order of priority. As a determination method of the length of the transmission time of each AGV 107, the number of bytes of information to be transmitted is included in the request of transmission slot assignment 1302 and the length of the transmission time is determined as the time required to transmit the number of bytes.

With reference to FIG. 17, a work flow of the control function of cooperative work of AGV and robotics arm 402 of the cooperative work control device 102 will be described.

The work flow is substantially the same as that of FIG. 9 in the first embodiment, and Step 1701 is added between Step 908 and Step 909.

In Step 1701, a value to be registered in the priority order field 1402 of FIG. 14 is calculated and registered. This calculation is carried out by the following procedure. Priorities are given in descending order of the difference between the value of the distance-from-destination field 606 and the value of the current moving speed field 608. However, if the value of the current moving speed field 608 is equal to the value of the distance-from-destination field 606, the priority is not given because there is no need to decelerate and a deceleration instruction is not necessary.

In addition, if the value of the distance-from-destination field 606 is larger than the value of the length-of-area-of-cooperative-work field 604, the priority is not given. Then, the priority order notification 1301 including the value of the moving body ID field 602 and the value of the priority order field 1402 is transmitted to the control function of assigning order 1201 of the base station 104.

### Third Embodiment

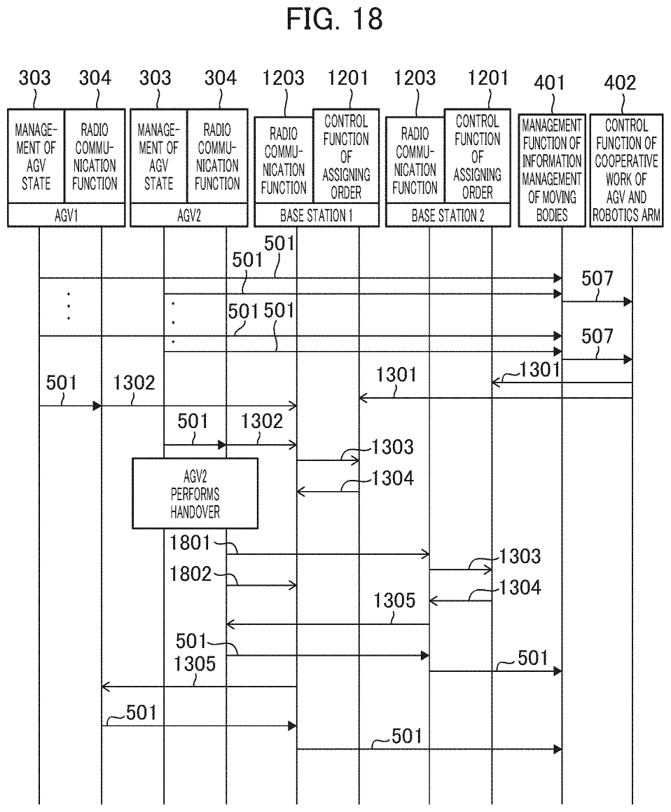

With reference to FIG. 18, a configuration of a cooperative work control system 101 of a third embodiment will be described.

The system configuration is the same as that of the cooperative work control system 101 of the first embodiment shown in FIG. 1, and the description thereof will be omitted.

A case in which when there are two base stations 104 in the second embodiment and the AGV 107 performs radio communications with the cooperative work control device 102, handover of the base stations 104 is performed will be described. Even in the case where there are three or more base stations 104, the same operation can be performed.

FIG. 18 is a sequence diagram for showing a case in which the AGV1 and the AGV2 are connected to a base station 1 and the AGV2 performs handover from the base station 1 to a base station 2 after the AGV2 approaches the robotics arm. FIG. 18 is substantially the same as FIG. 13 except for the following 3 points.

The first point is that the AGV 107 and the control function of cooperative work of AGV and robotics arm 402 transmit the priority order notification 1301 to all the base stations 104. The contents of the notification are the same and the priorities of all the AGVs 107 are notified. The work of the control function of assigning order 1201 having received the priority order notification 1301 is the same as that of the second embodiment.

The second point is that the AGV2 performs a handover process. Specifically, a request of connecting 1801 is transmitted to the base station 2 as the handover destination, and a request of disconnecting 1802 is transmitted to the base station 1. There are various methods of determining whether or not to perform handover. For example, there is a method of selecting a base station having a larger value by comparing the received signal intensities of radio waves transmitted from the base station 1 and the base station 2.

The third point is a handover process in the base station 104. When receiving the request of disconnecting 1802, the radio communication function 1203 of the base station 1 cancels the request of transmission slot assignment 1302 received immediately before from the AGV2. The subsequent processes are the same as those in the second embodiment. When receiving the request of connecting 1801, the radio communication function 1203 of the base station 2 performs the same process as that performed when receiving the request of transmission slot assignment 1302. That is, the request of assigning order 1303 is transmitted to the control function of assigning order 1201. The subsequent processes are the same as those in the second embodiment.

According to the above embodiment, the work efficiency of the cooperative work can be improved by shortening the work time of one cycle of the cooperative work when the tow devices repeat the cooperative work.

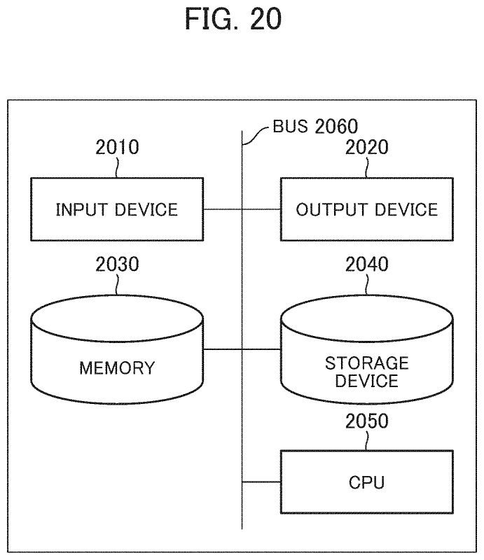

Here, the cooperative work control device 102 shown in FIG. 1 is configured using a computer in which an input device 2010, an output device 2020, a memory 2030, a storage device 2040, and a CPU 2050 are connected to each other via a bus 2060 as shown in FIG. 20.

In addition, the “functions” shown in FIGS. 2, 3, and 4 are realized by, for example, executing programs by a processor (CPU or the like). For example, the arm control function 202 shown in FIG. 2 is equivalent to an “arm control unit” that realizes an arm control function by executing a program by a processor. Thus, each of the above-described “functions” can be replaced with a “unit”.

What is declared is:

1. A cooperative work control system comprising:
a first device for performing a first work;
a second device for performing a second work in cooperation with the first work of the first device; and
a cooperative work control device for controlling the first work of the first device and the second work of the second device,
wherein the cooperative work control device collects the working status of the first work of the first device and controls the second work of the second device on the basis of the working status.

2. The cooperative work control system according to claim 1,
wherein the cooperative work control device controls the second work of the second device using a throughput value that is the number of works of the first work that can be executed per unit time by the first device as the working status.

3. The cooperative work control system according to claim 2,
wherein when the cooperative work control device detects that the second device is moving inside an area of cooperative work where the second device can work in cooperation with the first work of the first device, the moving speed of the second device is controlled as the control of the second work of the second device on the basis of the throughput value.

4. The cooperative work control system according to claim 3,
wherein the area of cooperative work is determined in advance in accordance with the capability of the first device with the first device as a base point, and
wherein the first device performs the first work while the second device moves inside the area of cooperative work.

5. The cooperative work control system according to claim 3,
wherein the cooperative work control device further controls the moving speed of the second device in accordance with the dimension of the area of cooperative work.

6. The cooperative work control system according to claim 3,
wherein when the second device moves outside the area of cooperative work, the second device moves at a normal moving speed, and
wherein when the second device moves inside the area of cooperative work, the cooperative work control device controls the moving speed of the second device to a deceleration moving speed slower than the normal moving speed on the basis of the throughput value.

7. The cooperative work control system according to claim 3,
wherein the cooperative work control device determines a timing for changing the moving speed of the second device on the basis of the throughput value.

8. The cooperative work control system according to claim 7,
wherein the cooperative work control device determines a deceleration timing for decelerating the second device on the basis of the current location, the current moving speed, and the deceleration performance of the second device and the throughput value of the first device, decelerates the moving speed of the second device so as to satisfy the throughput value of the first device inside the area of cooperative work, determines an acceleration timing for accelerating the moving speed of the second device after the first work of the first device is completed, and controls the moving speed of the second device so as to be accelerated outside the area of cooperative work.

9. The cooperative work control system according to claim 3, further comprising an input display device for displaying a setting input screen and a status display screen,
wherein the dimension of the area of cooperative work is input through the setting input screen, and
wherein the cooperative work control device displays a positional relationship between the first device and the second device on a map through the status display screen.

10. The cooperative work control system according to claim 1, further comprising a base station for performing radio communications between the first device and the plurality of second devices, and the cooperative work control device,
wherein the base station determines an assigning order for performing the radio communications among the plurality of second devices.

11. The cooperative work control system according to claim 3,
wherein the second device is configured using an automated guided vehicle for carrying products,
wherein the first device is configured using a robotics arm for taking out the products carried by the automated guided vehicle,
wherein the area of cooperative work is determined in advance on the basis of a range where the robotics arm can take out the products carried by the automated guided vehicle in accordance with the performance of the robotics arm,
wherein the automated guided vehicle repeats carrying the products to the robotics arm as the second work, and
wherein the robotics arm repeats taking out the products from the automated guided vehicle as the first work.

12. A cooperative work control device for controlling a cooperative work in a first device and a second device that perform the cooperative work in cooperation with each other,
wherein the working status of a first work of the first device is collected, and
wherein a second work of the second device is controlled on the basis of the working status.

13. The cooperative work control device according to claim 12,
wherein the second work of the second device is controlled using a throughput value that is the number of works of the first work that can be executed per unit time by the first device as the working status.

14. The cooperative work control device according to claim 12,
wherein when detecting that the second device is moving inside an area of cooperative work where the second device can work in cooperation with the first work of the first device, the moving speed of the second device is controlled as the control of the second work of the second device on the basis of the throughput value.

15. A cooperative work control method for controlling a cooperative work in a first device and a second device that perform the cooperative work in cooperation with each other, comprising:
collecting the working status of a first work of the first device; and
controlling a second work of the second device on the basis of the working status.
